(19) United States
(12) Patent Application Publication
(10) Pub. No.: US 2006/0078753 A1
(43) Pub. Date: Apr. 13, 2006

(54) Adaptable Protective Membrane

(76) Inventors: Mark Bomberg, Ottawa (CA); Stuart D. Carlisle, Attleboro, MA (US)

Correspondence Address: BOND, SCHOENECK & KING, PLLC, ONE LINCOLN CENTER, SYRACUSE, NY, 13202-1355, US

(21) Appl. No.: 11/160,017

(22) Filed: Jun. 6, 2005

Related U.S. Application Data
(60) Provisional application No. 60/577,705, filed on Jun. 7, 2004.

(51) Int. Cl. B32B 23/08; B32B 29/00; B32B 21/04; B32B 27/06

(52) U.S. Cl. 428/479.3; 428/507; 428/537.1; 428/537.7

(57) ABSTRACT

A composite, flexible and layered system and method which performs as an adaptable protective membrane (APM). The APM controls the passage of air, liquid water, and water and changes its moisture permeability with the change of humidity on its surface. APM comprises at least two layers with or without additional surface treatments. The first layer is a matrix comprised of a non-woven fibrous material, such as building paper made from cellulose fibers, building paper saturated with asphalt, a combination of cellulose fibers and other synthetic adsorbent fibers, or synthetic polymer fibers that change the rate of water vapor transmission with the moisture content of the membrane. The second layer is a polymer including ingredients to modify its water transport ability. The second layer may be an extrusion coated, liquid applied, or a spray applied coating. The APM is a directionally sensitive membrane, i.e., the flow resistance for moisture transferred from the first layer to the second layer that is different from the flow of moisture from the second layer to the first layer.

### CROSS REFERENCE

The present application claims priority to U.S. Provisional Application Ser. No. 60/577,705 filed Jun. 7, 2004, hereby incorporated by reference.

### FIELD OF THE INVENTION

The present invention relates to building materials and, more specifically, to composite materials used in the construction of buildings to control water penetration and water vapor transmission through a building enclosure.

### DESCRIPTION OF PRIOR ART

Conventional water vapor or moisture controlling elements in building enclosures focus on the reduction or elimination of moisture entry into building materials or components. For example, film-forming compositions may be used to make vapor barrier films having low water vapor transmission, good flame retardance, and low smoke generation. In some instances, a coating of polypropylene resin is applied to the surface of a fibrous sheet to make the sheet impermeable to water and vapor. Subsequent calendering provides vapor permeability to the sheet while maintaining liquid water impermeability. The resultant product is particularly suited for use as a roofing-tile underlayment or as an air-infiltration barrier. Alternatively, barriers may be coated with other elastomers, include dispersed layer fillers in liquid carriers, or include a sheet of paper impregnated with urethane or polyisocyanurate compounds.

Other barrier products may comprise laminates with a reinforcing layer having a first tensile strength that is laminated to a flexible cellulose web having an open porosity and a second tensile strength which is less than the first tensile strength. The web is then treated with a water-resistant polymeric resin for providing liquid water resistance while permitting water vapor to diffuse through it.

Some conventional building products include laminate structures that are physically punctured to provide the requisite permeability, such as a two-ply film that has micro-punctures to allow vapor transmission from the first side to the second side of the laminate. Another example of a physically perforated barrier is the lamination of a fabric that is impermeable to liquids and permeable to vapor to a porous fibrous web that is then perforated with fine conical needles to provide micro-pores penetrating through the film. Other laminates may be composed of a paper ply that is cold-laminated with a water-based adhesive to a reinforcing ply formed by an oriented synthetic plastic film, such as polypropylene, that imparts tear and burst strength to the sheeting. The sheeting is foraminated to create a myriad of fine pores that render the sheeting permeable to moisture vapor, but effectively impermeable to liquids. An additional ply of metalized paper may be cold-laminated to either side of the foraminated sheet.

Other barrier products may include a substrate of a water-impermeable material having a coating with an ionic charge. Some systems include two vapor-tight layers which are separated by a water-absorbing layer that is exposed to the environment to allow evaporation of moisture.

One vapor barrier includes three types of polyamide (nylon) fibers that are modified with polyvinyl alcohol. Since these fibers are susceptible to moisture, the water vapor permeance of membrane changes with relative humidity. Another conventional barrier comprises a sheet of a unitary, non-woven material that is spun-bonded from synthetic plexifilamentary fibers. The sheet is then textured with protrusions in a random polyhedral pattern to define channels oriented in multiple directions that provide by which a liquid on the first side of the sheet can drain.

### Objects and Advantages

It is a principal object and advantage of the present invention to provide a system and method for dealing with the moisture encapsulated during construction of a building or enclosure.

It is an additional object and advantage of the present invention to provide a system and method for dealing with the moisture that comes from incidental leaks or failures of the vapor barrier of a building or enclosure.

It is a further object and advantage of the present invention to provide a system and method for providing accelerated moisture absorption, storage and transfer.

It is another object and advantage of the present invention to provide a system and method for improved transfer of moisture to adjacent material having a higher activity index or higher storage capability.

Other objects and advantages of the present invention will in part be obvious, and in part appear hereinafter.

### SUMMARY OF THE INVENTION

The present invention comprises an adaptable protective membrane (APM) having a matrix layer and a polymer layer. The matrix layer generally comprises a cellulose layer formed from conventional barrier paper impregnated with asphalt. The matrix layer may also be a non-woven structure made from a combination of cellulose fibers and other synthetic adsorbent fibers, or a non-woven structure made from other synthetic polymer fibers having adsorbent, hygroscopic, or hydrophilic properties. The polymer layer is formed from a polyurethane or carboxylated SBR that is liquid or spray coated on the matrix layer. A layer of coating with or without embedded hygroscopic powder, e.g., diatomous earth, fly ash, or bark, may be applied to the inner or outer surfaces of the matrix and polymer layer to further enhance the performance characteristics of the APM.

### BRIEF DESCRIPTION OF THE DRAWINGS

The present invention will be more fully understood and appreciated by reading the following Detailed Description in conjunction with the accompanying drawings, in which:

FIG. 1 is a cross-sectional schematic of an adaptable protective membrane according to the present invention.

### DETAILED DESCRIPTION

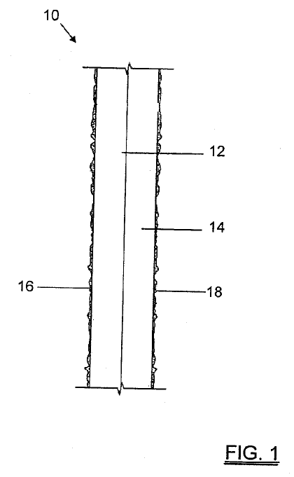

Referring now to the drawings, wherein like numerals refer to like parts throughout, there is seen in FIG. 1 an adaptive protective membrane (APM) 10 for controlling the rate of air, vapor, and liquid water flow from one environmental condition to another. In residential and commercial construction practice, APM 10 restricts the passage of air and liquid water while permitting the transfer of water vapor to a degree required. The rate of water vapor transmission across the membrane may be controlled but it varies with the moisture content of APM 10.

APM 10 comprises a matrix layer 12 and a polymer layer 14. Matrix layer 12 of APM 10 is a non-woven fibrous material, such as a building paper made from cellulose fibers, a paper saturated with asphalt, a non-woven combination of cellulose fibers and synthetic adsorbent fibers, or a non-woven combination of synthetic polymer fibers having the target adsorbent, hygroscopic or hydrophilic properties. Matrix layer 12 provides a surface with a high affinity to water molecules and captures moisture (or vapor) from the adjacent material (or air space) to the maximum possible extent. The cellulose fiber matrix of matrix layer 12 is inherently a moisture sensitive material, i.e., its ability to transfer moisture changes with the changes in relative humidity (RH) to which it is exposed. At a low RH, matrix layer 12 has a resistance to water vapor diffusion significantly higher than that at a high RH.

Matrix layer 12 may be treated with water repellant comprising either natural or synthetic polymers (e.g., wax or asphalt) to improve its durability under conditions involving presence of water. The required degree of treatment depends on physical properties of the adjacent layers. When matrix layer 12 is enclosed by a coating on one side and polymer layer 14 on the other side, it may remain untreated. When exposed to interim wetting and drying, matrix layer 12 is preferably partly saturated with asphalt. Matrix layer 12 may also be pre-treated with ingredients which act as biocides and enhance protection of the membrane from microbial deterioration in the form of mold, mildew and wood rot.

Different compounds may be used to impregnate matrix layer 12. An inorganic layered silicate, such as bentonite, vermiculite, or montmorillonite, may be used. Matrix layer 12 may also be impregnated with an alkali metal polysilicate solution, such as lithium (Li), potassium (K) or sodium (Na), preferably having a molar ratio of SiO₂ to Li₂O of about 4:1. Potassium polysilicate may also be used because it changes barrier performance at higher relative humidity range. Methods for applying the selected particulate such as diatomous earth, fly ash, or bark to matrix layer 12 include brushing, spraying, rolling, and centrifugal or other processes.

Polymer layer 14 of APM 10 comprises one or more plies of a synthetic polymer incorporating ingredients to modify its ability to transport air, water and water vapor. Polymer layer 14 can be an extrusion coated, liquid applied or a spray applied coating and enhances for the mechanical performance of APM 10.

Polymer layer 14 is applied to the surfaces of matrix layer 12 and preferably comprises an emulsion or solvent dispersion of a polyurethane polymer, or a mixture of polyurethane and latex. Alternatively, latex acrylic or styrene butadiene rubber may be used. Other polymers useful for forming the polymer layer 14 of the present invention are emulsions of vinyl acetate-ethylene polymers, vinyl acetate homopolymers and vinyl acrylic polymers, and layered silicates dispersed in an aqueous metal polysilicate. Polyethylene or EMA (ethylene methyl acrylate) are examples of other suitable candidates for polymer layer 14. The extrusion of the polymeric film for polymer layer 14 may be mixed with fillers or biocides as needed. More than one ply of polymer layer 14 can be incorporated into APM 10 to expand the range of control of polymer layer 14 over air, water, and vapor transport.

Examples of methods of application are rod coatings, sponge coatings, reverse roll coatings, knife over roll coatings, slot die coatings, or gravure coatings. Drying of the coating can be accomplished with natural or forced convection, or through the use of heat lamps. While extruded film is more expensive, it provides a simple method for incorporating fibers with a particular orientation that will facilitate the movement of moisture along the surface of APM 10 in a particular direction towards drainage.

APM 10 may thus include a drainage capability and a resistance against the entry of liquid water that may find its way to the surface of APM 10. Generally, the control of the resistance to liquid water penetration while maintaining an ability to transfer both air and water vapor at desired levels is achieved by the pore structure of each sub-layer of APM 10, as well as by the interface between matrix layer 12 and polymer layer 14 that constitutes the contrast between hygroscopic/hydrophilic and hydrophobic nature of the two main sub-layers.

The composite laminate structure of APM 10 is also less susceptible to damage and any bending, folding, wrinkling of a sheet of APM 10 is less likely to compromise performance. APM 10 also has improved resistance to cracking, punctures or tears, in comparison to conventional building paper.

The rate of air and water vapor transfer needed in a typical construction application depends on both on the climate and service conditions as well as degree of control required for the specific application. Thus, the selection of the air, water and vapor controlling properties of APM 10 relates to required durability of wall assemblies and the exterior/interior climatic conditions.

The present invention may include the design of at least three separate classes of APM 10 that are designated for use in various climates, according to standard building specification. To achieve the required level of durability, it is required that the onset of liquid flow under a differential pressure of 50 Pa should not occur in a period shorter than 48 hours when testing APM 10 on liquid penetration resistance. The three primary classes of APM 10 differ primarily in their water vapor transmission ability.

The first class of APM 10 is generally impermeable, and has a water vapor permeability coefficient measured by ASTM E96 dry cup method of between 0.1 perm and 0.5 perm (6 to 28 ng/(m²sPa) for exterior use in hot and humid climates and in the middle of wall assemblies in mixed and humid climates. If the rate of air transmission of APM 10 tested at 50 Pa is lower than 0.02//m²sPa, than this material is also suitable for air control in hot an humid environments.

The second class of APM 10 is semi-permeable, and has a water vapor permeability coefficient measured by ASTM E96 dry cup method between 3 perm to 7 perm (170 to 400 ng/(m²sPa) for interior use in cold climates.

The third class of APM 10 is fully permeable, and has water vapor permeability coefficient measured by ASTM E96 dry cup method between 10 perm and 20 perm (570 to 1140 ng/(m²sPa) for exterior use in cold climates. As explained above, each class exhibits a change in the transmission rate between environments having low and high relative humidity.

If water is supplied to one side of APM 10, the resistance for moisture transferred through APM 10 is different when it goes from matrix layer 12 to polymer layer 14 than when moisture is transferred from polymer layer 14 to matrix layer 12. Thus, APM 10 has a directional sensitivity. Typically, the directional sensitivity exceeds a factor of two, as seen in the Tables below.

As a result of this directional sensitivity, APM 10 may be used for the rehabilitation of basement walls. APM 10 applied to the interior finish of a basement wall will provide a much higher rate of moisture transport from the basement wall than in the opposite direction.

APM 10 also provides additional protection measure from moisture that is enclosed during the construction process, or that infiltrates from incidental water leakage. For enhanced dissipation of incidental water leakage, polymer layer 14 may include a granular finish layer or fibers that are oriented to in a preferred direction on the surface of APM 10. APM 10 may thus be used in many applications where enhanced moisture removal is required, such as a cover on concrete slabs, on walls prone to heavy rain loads, on concrete block walls in basements, or other applications where enhanced drying capability is needed.

### EXAMPLE

Several laboratory samples of APM 10 were prepared and tested. The samples of APM 10 were constructed using a standard commercially available asphalt saturated Kraft paper manufactured by Fortifiber of Incline Village, Nev. under the trade name Jumbo Tex® as matrix layer 12. The paper was a nominal 26 pounds per 1000 square feet natural Kraft liner board saturated with approximately 7 pounds per 1000 square feet of asphalt.

Polymer layer 14 was prepared by hand coating matrix layer 12 with a water-based latex coating, such as carboxylated styrene-butadiene latex available from Mallard Creek Polymers, Inc. of Charlotte, N.C., and latex emulsion polyurethane coatings available from Mace Adhesives & Coatings Co., Inc of Dudley, Mass. The physical properties of these samples were then tested and the results are presented in Table 1 below.

Table 1

TABLE 1

| | | | | | ASTM D779 | | | | | |
|---|---|---|---|---|---|---|---|---|---|---|
| | | | | | Water | | | | ASTM | |
| | | | | | Resistance | | ASTM F1249 | | F1249 | |
| | | AVG | | Coating | Dry | | WVTR | | Mocon @ | WVTR |
| | Polymer | Thickness | AVG Wt | AVG Wt | Indicator | | Mocon @ 73 F., 50% | | 73 F. and | Testing 50% |
| | layer | (mils) | (#/1000 s) | (#/1000 sf) | Method (min) | | RH gms/sq M/day | | permeance | RH (per ms) |
| Sample | | | | | | Polymer | Polymer | Polymer | Polymer | Polymer |
| ID | | | | | | on vapor | on dry | on vapor | on dry | on vapor |
| | | | | | | side | side | side | side | side |
| Jumbo | none | 8.7 | 35.4 | 0 | 32.5 | same | Exceeds | | | |
| Tex | | | | | | | measurement | | | |
| Building | | | | | | | | | | |
| Paper | | | | | | | | | | |
| SDC1-34-1 | C-SBR | 9.2 | 39.6 | 4.21 | 135 | 270 | 23 | 17 | 3.3 | 2.4 |
| 96-219-1 | Poly- | 9.3 | 40.0 | 4.62 | 41 | 175 | 41 | 43 | 5.9 | 6.2 |
| | urethane | | | | | | | | | |
| 96-219-2 | Poly- | 9.3 | 40.1 | 4.76 | 46 | 135 | 39 | 41 | 5.6 | 5.8 |
| | urethane | | | | | | | | | |
| 96-219-3 | Poly- | 10.4 | 43.8 | 8.39 | 60 | 203 | 40 | 44 | 5.7 | 6.3 |
| | urethane | | | | | | | | | |
| 96-220-1 RT | Poly- | 10.3 | 44.1 | 8.70 | 75 | 390 | na | na | na | na |
| | urethane | | | | | | | | | |
| 96-220-1 | Poly- | 9.9 | 43.3 | 7.92 | 380 | 55 | na | na | na | na |
| Baked | urethane | | | | | | | | | |
| SDC 1-37-1 | C-SBR | 9.7 | 39.9 | 4.56 | 140 | >340 | 24 | 25 | 3.4 | 3.5 |
| (V1) | Vancide | | | | | | | | | |
| | Microbial | | | | | | | | | |
| SDC 1-37-2 | C-SBR | 9.4 | 41.0 | 5.58 | 150 | >340 | 18 | 44 | 2.6 | 6.3 |
| (V2) | Microban | | | | | | | | | |
| | LB6 | | | | | | | | | |
| SDC 1-37-3 | C-SBR | 9.3 | 40.3 | 4.93 | na | na | 18 | 44 | 2.6 | 6.3 |
| (V3) | no biocide | | | | | | | | | |

Table 2 shows tear and tensile strength of the samples of APM 10 in comparison to conventional products. Matrix layer 12 of APM 10 was formulated from commercially available building paper, i.e., Kraft paper having a weight of 26 pounds per 1000 square feet that is saturated with asphalt. Polymer layer 14 was formulated as indicated in Table 2.

Table 2

TABLE 2

| | Matrix layer 12 | | Polymer layer 14 | | | | | | | |
|---|---|---|---|---|---|---|---|---|---|---|
| | Standard Jumbo Tex | | Mace | SDC1- | Mace | SDC1- | Mace | SDC1- | Mllrd Creek | SDC1- |
| | | Standard | 96-219-2 | 44-1 | 96-237-1 | 44-2 | 96-239-1 | 44-3 | Rovene4002 | 44-4 |
| | Average | deviation | Avg | Avg | Avg | Avg | Avg | Avg | Avg | Avg |
| Meyer Rod # | na | | 10 | 32 | 10 | 32 | 10 | 32 | 10 | 32 |
| Coating | na | | 920 | | 260 | | 80 | | 460 | |
| Viscosity, cps | | | | | | | | | | |
| Thickness, mils | 8.68 | 0.17 | 8.92 | 9.12 | 8.90 | 9.15 | 8.90 | 9.25 | 8.95 | 10.30 |
| Weight, | 143 | 2 | 158 | 164 | 153 | 163 | 150 | 162 | 156 | 175 |
| gms/sq yd | | | | | | | | | | |
| Weight, | 35.1 | 0.4 | 38.8 | 40.1 | 37.5 | 39.8 | 36.7 | 39.6 | 38.1 | 42.8 |
| lbs/1000 SF | | | | | | | | | | |
| Coat Weight, | na | | 15 | 21 | 10 | 19 | 6 | 18 | 12 | 32 |
| gms/sq yd | | | | | | | | | | |
| Coat Weight, | na | | 3.6 | 5.0 | 2.3 | 4.7 | 1.6 | 4.5 | 3.0 | 7.7 |
| lbs/1000 SF | | | | | | | | | | |
| Adhesion to | 10.8 | 0.5 | 23.0 | 15.8 | 21.2 | 21.0 | 5.2 | 4.6 | 14.4 | 26.5 |
| Coating, oz/in | | | | | | | | | | |
| Failure Mode | pulled some | | ctng | ctng | ctng | ctng | adhsv | adh | ctng delam | adh |
| Description | fibers | | delam | delam | delam | delam | fail | fail | | fail |
| Water | | | | | | | | | | |
| Resistance, min | | | | | | | | | | |
| Coating up | 26 | 1 | 26 | 33 | 35 | 45 | 40 | 40 | 45 | 55 |
| Coating down | same | NA | 76 | 122 | 63 | 187 | 90 | 100 | 160 | 225 |
| Tensile | 65 | 4 | 64 | 67 | 66 | 66 | 66 | 68 | | |
| Strength, MD | | | | | | | | | | |
| Tear Strength, | 95 | 11 | 126 | 208 | 126 | 238 | 104 | 135 | 128 | 160 |
| CD (lrgr wt) | | | | | | | | | | |
| % Increase due | 0.0% | | 33% | 119% | 33% | 150% | 9% | 42% | 35% | 68% |
| to Ctng Inc | | | | | | | | | | |

Hygric properties of several APM 10 products were tested with MIC test methods, i.e., between 5 mm thick horizontal water layer on top of the tested membrane and desiccant below the membrane. The results of the MIC test are reported in Table 3 below. Water vapor permeability (water to desiccant) is shown in IP units measured according to the MIC method.

Table 3

TABLE 3

| Product | | | | | | | | | Test | Material | % change |
|---|---|---|---|---|---|---|---|---|---|---|---|
| Surface | Product code | Permeability of water to desiccant, Perms (IP Units) | | | | | | | average | average | (S2 − S1)/S1 |
| S1 | 1-64-1Ref | 47.74 | 49.01 | 47.75 | 46.33 | 46.83 | 48.23 | 48.59 | 47.79 | | within |
| S1 | 1-64-1Ref | 51.92 | 52.07 | 49.84 | 47.08 | 47.93 | 51.37 | 49.69 | 49.66 | 49.23 | material |
| S2 | 1-64-1Ref | 49.63 | 51.86 | 50.37 | 47.99 | 46.11 | 49.23 | 51.95 | 49.58 | 49.77 | differences |
| S2 | 1-64-1Ref | 49.33 | 51.46 | 50.70 | 48.07 | 46.08 | 50.32 | 53.10 | 49.96 | | |
| S1 | 1-64-4H | 22.14 | 18.51 | 18.69 | 18.78 | 18.01 | 18.01 | 17.99 | 18.33 | | |
| S1 | 1-64-4H | 10.90 | 10.94 | 10.62 | 10.65 | 10.88 | 11.89 | 10.26 | 10.87 | 14.60 | 221 |
| S2 | 1-64-4F | 46.89 | 50.16 | 49.35 | 46.50 | 45.87 | 46.09 | 50.46 | 48.07 | 46.83 | |
| S2 | 1-64-4F | 43.74 | 46.50 | 46.47 | 44.53 | 43.53 | 44.42 | 48.85 | 45.71 | | |
| S1 | 1-64-8E | 4.97 | 5.06 | 5.31 | 5.33 | 5.60 | 5.58 | 5.64 | 5.42 | | |
| S1 | 1-64-8E | 4.94 | 5.25 | 5.21 | 5.61 | 5.94 | 6.02 | 6.19 | 5.70 | 5.56 | 118 |
| S2 | 1-64-8C | 11.57 | 12.22 | 12.57 | 13.00 | 13.03 | 13.24 | 12.87 | 12.82 | 12.12 | |
| S2 | 1-64-8C | 10.83 | 10.73 | 11.74 | 11.65 | 11.63 | 11.72 | 11.75 | 11.54 | | |
| S1 | 1-64-5G | 3.33 | 2.89 | 3.50 | 3.69 | 3.54 | 3.69 | 3.59 | 3.48 | | |
| S1 | 1-64-5G | 2.96 | 2.74 | 3.48 | 3.49 | 3.51 | 3.39 | 3.59 | 3.37 | 3.43 | 82 |
| S2 | 1-64-5 | 5.37 | 5.86 | 6.67 | 6.88 | 7.04 | 7.18 | 7.18 | 6.80 | 6.24 | |
| S2 | 1-64-5 | 4.01 | 4.32 | 5.58 | 5.58 | 6.24 | 6.37 | 6.00 | 5.68 | | |
| Test | time (h) | 24 | 48 | 72 | 98 | 136 | 160 | 184 | | | |

What is claimed is:

1. An adaptable protective membrane, comprising:
a matrix layer having moisture sensitivity; and
a polymer layer adhered to at least one side of said matrix layer, wherein the water vapor permeability of said membrane is directionally sensitive.

2. The membrane of claim 1, wherein said matrix layer is treated with at least one compound selected from the group consisting of wax, asphalt, and colloidal clay.

3. The membrane of claim 1, further comprising a surface finish on said matrix layer.

4. The membrane of claim 3, wherein said surface finish comprises at least a hygroscopic compound selected from the group consisting of diatomous earth, fly ash and bark particles.

5. The membrane of claim 3, wherein said surface finish comprises a polymeric film.

6. The membrane of claim 1, wherein said polymer layer comprises a compound selected from the group consisting of polyolefin, urethane, and synthetic latex.

7. The membrane of claim 6, wherein said polymer layer includes a granular admixture.

8. The membrane of claim 1, further comprising a surface finish on said polymer layer.

9. The membrane of claim 8, wherein said second surface finish comprises at least one compound selected from the group consisting of diatomous earth, fly ash and bark particles.

10. The membrane of claim 8, wherein said second surface finish comprises a polymeric film having a fiber matrix.

11. The membrane of claim 1, wherein said polymer layer comprises a polyurethane dispersion.

12. The membrane of claim 1, wherein said polymer layer comprises latex acrylic.

13. The membrane of claim 1, wherein said polymer layer comprises latex rubber.

14. The membrane of claim 1, wherein said matrix layer is impregnated with an inorganic layered silicate.

15. The membrane of claim 14, wherein said inorganic layered silicate comprises at least one compound selected from the group consisting of bentonite, vermiculite, and montmorillonite.

16. The membrane of claim 14, wherein said inorganic layered silicate comprises an alkali metal polysilicate solution.

17. The membrane of claim 16, wherein said alkali metal polysilicate solution further comprises at least one element selected from the group consisting of lithium, potassium, and sodium.

18. The membrane of claim 1, further comprising a biocide applied to said matrix layer and said polymer layer.

19. The membrane of claim 1, further comprising a third layer having oriented fibers positioned against said first matrix and opposite to said polymer layer.

20. The membrane of claim 1, further comprising a third layer having oriented fibers positioned against said second layer opposite said first layer.

21. The membrane of claim 1 wherein said matrix layer has a basis weight of at least 25 g/m².

22. The membrane of claim 1, wherein the water vapor permeability is at least 60% higher from one side than from the other side.

23. The membrane of claim 1, further comprising fillers for improving the radiant barrier properties of said membrane.

24. The membrane of claim 23, wherein said fillers comprise pigments.

25. The membrane of claim 1, further comprising a polymeric scrim positioned between said matrix layer and said polymer layer.

26. The membrane of claim 1, wherein said polymer layer has an average thickness between 3 and 250 microns.

27. The membrane of claim 1, wherein said matrix layer includes micro-pores oriented to enhance the transport of air and moisture along the membrane.

28. The membrane of claim 1, wherein said membrane has an air permeability rate at 50 Pa lower than 0.02//m²sPa.

29. The membrane of claim 1, wherein said membrane prohibits liquid flow therethrough at 50 Pa for at least 48 hours.

30. The membrane of claim 1, wherein said membrane has a water vapor permeability of between 0.1 to 0.5 perms (6 to 28 ng/m²sPa) when measured with the ASTM E96 standard test.

31. The membrane of claim 1, wherein said membrane has a water vapor permeability of between 10 to 20 perms (570 to 1140 ng/m²sPa) when measured with the ASTM E96 standard test.

32. A method of manufacturing an adaptable protective membrane, comprising the steps of:
selecting a matrix layer having moisture sensitivity; and
coating at least one side of said matrix layer with at least one polymer layer so that the water vapor permeability of said membrane is directionally sensitive.

33. The method of claim 32, further comprising the step of applying a hygroscopic finishing layer to said matrix layer.

34. The method of claim 33, wherein said hygroscopic finishing layer comprises at least one compound selected from the group consisting of diatomous earth, fly ash, or bark particles.

35. The method of claim 33, wherein said hygroscopic finishing layer comprises a polymeric film including a particulate or fiber matrix.

36. The method of claim 32, further comprising the step of applying a hygroscopic finishing layer to said polymer layer.

37. The method of claim 36, wherein said hygroscopic finishing layer comprises at least one compound selected from the group consisting of diatomous earth, fly ash, or bark particles.

38. The method of claim 36, wherein said hygroscopic finishing layer comprises a polymeric film including a particulate or fiber matrix.

39. The method of claim 32, wherein said polymer layer comprises at least one compound selected from the group consisting of polyurethane, polyurethane and latex, latex acrylic, styrene butadiene rubber, vinyl acetate-ethylene, vinyl acetate, vinyl acrylic, polyethelyne, and ethylene methyl acrylate.

40. The method of claim 32, further comprising the step of drying said polymer layer after coating said matrix layer.

41. The method of claim 32, further comprising the step of treating said matrix layer with a water repellant.

42. The method of claim 40, wherein said water repellant comprises natural polymers.

43. The method of claim 40, wherein said water repellant comprises synthetic polymers.

44. The method of claim 32, further comprising the step of at least partially impregnating said matrix layer with an inorganic layered silicate.

45. The method of claim 43, wherein said inorganic layered silicate at least one compound selected from the group consisting of bentonite, vermiculite, and montmorillonite.

46. The method of claim 43, wherein said inorganic layered silicate comprises an alkali metal polysilicate solution.

47. The membrane of claim 45, wherein said alkali metal polysilicate solution further comprises at least one element selected from the group consisting of lithium, potassium, and sodium.

48. The method of claim 32, further comprising the step of treating said matrix layer with a biocide.

49. The method of claim 32, further comprising the step of treating said polymer layer with a biocide.

50. The method of claim 32, further comprising the step of applying a layer of oriented fibers to said matrix layer.

51. The method of claim 32, wherein said matrix layer has a basis weight of at least 25 g/m².

52. The method of claim 32, wherein the water vapor permeability is at least 60% higher from one side of said membrane than from the other side.

53. The method of claim 32, further comprising the step of adding fillers for improving the radiant barrier properties of said membrane.

54. The method of claim 52, wherein said fillers comprise pigments.

55. The method of claim 32, further comprising the step of positing a polymeric scrim against said matrix layer prior to coating with said polymer layer.

56. The method of claim 32, wherein said polymer layer has an average thickness between 3 and 250 microns.

57. The method of claim 32, wherein said matrix layer includes micro-pores oriented to enhance the transport of air and moisture along said membrane.

58. The method of claim 32, wherein said membrane has an air permeability rate at 50 Pa lower than 0.02//m²sPa.

59. The method of claim 32, wherein said membrane prohibits liquid flow therethrough at 50 Pa for at least 48 hours.

60. The method of claim 32, wherein said membrane has a water vapor permeability of between 0.1 to 0.5 perms (6 to 28 ng/m²sPa) when measured with the ASTM E96 standard test.

61. The method of claim 32, wherein said membrane has a water vapor permeability of between 10 to 20 perms (570 to 1140 ng/m²sPa) when measured with the ASTM E96 standard test.
